(19) United States
(12) Patent Application Publication
(10) Pub. No.: US 2020/0125915 A1
(43) Pub. Date: Apr. 23, 2020

(54) FOIL TAG

(71) Applicant: AVERY DENNISON RETAIL INFORMATION SERVICES, LLC, Mentor, OH (US)

(72) Inventor: Ian J. FORSTER, Chelmsford (GB)

(21) Appl. No.: 16/656,808

(22) Filed: Oct. 18, 2019

Related U.S. Application Data
(60) Provisional application No. 62/747,654, filed on Oct. 18, 2018.

(51) Int. Cl. G06K 19/077

(52) U.S. Cl. CPC G06K 19/07758

(57) ABSTRACT

An RFID antenna structure is disclosed that is formed from a portion of a conductive material from a container seal. Generally, minimal material is removed from the container seal to form the antenna which thus retains most of the barrier properties of the conductive material. Further, an RFID tag device is coupled to either an outside or an inside of the barrier layer, and is attached after the container has been sealed to prevent the RFID tag device from being damaged during the sealing process.

### CROSS REFERENCE TO RELATED APPLICATION(S)

The present application claims priority to and the benefit of United States provisional utility patent application No. 62/747,654 filed Oct. 18, 2018, which is incorporated herein by reference in its entirety.

### BACKGROUND

The present invention relates generally to forming a radio-frequency identification (RFID) antenna as part of a conductive material. Specifically, the antenna is formed by having minimal material removed, allowing the barrier properties of the material to be largely unaffected. The present subject matter is especially suitable for food and medication containers but can be used with other packaging arrangements having a foil or other conductive metal seal, e.g. cosmetics, paint, etc. In accordance with embodiments of the present subject matter, an RFID antenna is provided as part of the conductive material. Particular relevance is found in connection with sealed food and medication containers wherein the sealing process involves temperatures, pressures, or other factors that may damage or destroy the RFID device. Accordingly, the present specification makes specific reference thereto. However, it is to be appreciated that aspects of the present inventive subject matter are also equally amenable to other like applications as referenced above.

Radio-frequency identification (“RFID”) is the use of electromagnetic energy (“EM energy”) to stimulate a responsive device (known as an RFID “tag” or transponder) to identify itself and in some cases, provide additionally stored data. RFID tags typically include a semiconductor device commonly called the “chip” on which are formed a memory and operating circuitry, which is connected to an antenna. Typically, RFID tags act as transponders, providing information stored in the chip memory in response to a radio frequency (“RF”) interrogation signal received from a reader, also referred to as an interrogator. In the case of passive RFID devices, the energy of the interrogation signal also provides the necessary energy to operate the RFID device.

RFID tags may be incorporated into, associated with or attached to articles to be tracked. In some cases, the tag may be attached to the outside of an article with adhesive, tape, or other means and in other cases, the tag may be inserted within the article, such as being included in the packaging, located within the container of the article, sewn into a garment or applied to a tag or label that is connected to an article but stands away from the article. The RFID tags are manufactured with a unique identification number which is typically includes a simple serial number of a few bytes with a check digit attached. This identification number is incorporated into the tag during manufacture. The user cannot alter this serial/identification number and manufacturers guarantee that each serial number is used only once. This configuration represents the low cost end of the technology in that the RFID tag is read-only and it responds to an interrogation signal only with its identification number. Typically, the tag continuously responds with its identification number. Data transmission to the tag is not possible. These tags, passive UHF RFID tags, for example, are very low cost and are produced in enormous quantities.

Such read-only RFID tags typically are attached to an article, either permanently or removably, to be tracked and, once attached, the serial number of the tag is associated with its host article in a computer data base. Specifically, an object of the tag is to associate it with an article throughout the article's life in a particular facility, such as a manufacturing facility, a transport vehicle, distribution center or warehouse, a health care facility, a pharmacy storage area, or other environment, so that the article may be located, identified, and tracked, as it is moved from place to place. The RFID device can also be paired with a sensor or other device so that things such as temperature or humidity can be monitored along with the article. Tracking the articles through the facility can assist in generating more efficient dispensing and inventory control systems as well as improving work flow in a facility. This results in better inventory control and lowered costs. In the case of medical supplies and devices, it is desirable to develop accurate tracking, inventory control systems, and dispensing systems so that RFID tagged devices and articles may be located quickly should the need arise, and may be identified for other purposes, such as expiration dates or recalls.

Many RFID tags used today are passive in that they do not have a battery or other autonomous power supply and instead, must rely on the interrogating energy provided by an RFID reader to provide power to activate the tag so that the tag may respond to the interrogator. Passive RFID tags require an electromagnetic field of energy of a certain frequency range and certain minimum intensity in order to achieve activation of the tag and transmission of its stored data. Another choice is an active RFID tag; however, such tags require an accompanying battery to provide power to activate the tag, thus increasing the expense and the size of the tag and making them undesirable for use in a large number of applications.

Depending on the requirements of the RFID tag application, such as the physical size of the articles to be identified, their location, and the ability to reach them easily, tags may need to be read from a short distance or a long distance by an RFID reader. Furthermore, the read range (i.e., the range of the interrogation and/or response signals) of RFID tags is also limited.

Furthermore, when using food and medication containers or other perishable products, as well as other sealed containers, the RFID tag is typically secured to a part of the container that comes in contact with the container's contents. Thus, the RFID tag would need to be food safe and/or sterile. Additionally, the RFID tag is typically applied to the container before the container is sealed. However, the sealing process can damage or destroy the RFID tag if the process includes temperatures, pressures, or other factors, such as gamma sterilization.

What is needed therefore is a RFID tag device and/or system that allows the RFID tag to be placed away from any contact with the container's contents. What is also needed is a RFID tag device that can be secured after the container is sealed to prevent damage to the RFID tag device.

The present invention discloses an RFID antenna that is formed as part of a conductive material of a container, and wherein minimal material is removed to retain the barrier properties of the material for the container. Further, an RFID tag device is coupled outside the barrier layer of the material, such that the RFID tag device does not come in contact with the contents of the container. Additionally, the RFID tag device is coupled after the container is sealed to prevent damage to the RFID tag device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an RFID antenna that is formed from a conductive material or a portion thereof, for example from a container seal used to seal or close the container in which a consumable or other article is placed. Generally, minimal material is removed from the container seal to form the antenna which thus retains most of the barrier properties of the conductive material. Further, an RFID tag device is coupled to either an outside or an inside of the barrier layer, and is attached after the container has been sealed to prevent the RFID tag device from being damaged during the sealing process.

In a preferred embodiment, the container comprises anti-tamper (or tamper evident) embodiments wherein the RFID tag device is coupled to the outside of the barrier layer and contains an adhesive on it. Thus, when the lid of the container is secured in place, the adhesive and RFID tag device attaches to the interior of the lid. When the lid is removed, the RFID tag device or a portion of the antenna is ripped away from the barrier layer damaging the RFID tag device so that it no longer can be read or has a limited read range indicating some tampering or removal event has occurred. Additionally, when the RFID tag device is secured within the interior of the lid, and when the lid is removed, the RFID antenna is also pulled up and can be used as a tab to pull the barrier layer (or seal) off the container.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a top view of the RFID antenna structure in accordance with the disclosed architecture.

FIG. 2 illustrates a side view of the RFID antenna structure in accordance with the disclosed architecture.

FIG. 3 illustrates a bottom view of the RFID antenna within a lid of a container in accordance with the disclosed architecture.

FIG. 4 illustrates a bottom view of the RFID antenna within the conductive material in accordance with the disclosed architecture.

FIG. 5 illustrates a top view of the RFID antenna and RFID tag device within the conductive material in accordance with the disclosed architecture.

FIG. 6 illustrates a graph of the RFID antenna performance in accordance with the disclosed architecture.

FIG. 7A illustrates a top perspective view of the RFID antenna within a bag material in accordance with the disclosed architecture.

FIG. 7B illustrates a side perspective view of the RFID antenna within a bag material in accordance with the disclosed architecture.

FIG. 8A illustrates a top perspective view of another embodiment of the RFID antenna within a bag material in accordance with the disclosed architecture.

FIG. 8B illustrates a side perspective view of another embodiment of the RFID antenna within a bag material in accordance with the disclosed architecture.

FIG. 9A illustrates a top perspective view of the RFID antenna within a disk seal for a container in accordance with the disclosed architecture.

FIG. 9B illustrates a side perspective view of the RFID antenna within a disk seal for a container in accordance with the disclosed architecture.

FIG. 10A illustrates a top perspective view of another embodiment of the RFID antenna within a disk seal for a container in accordance with the disclosed architecture.

FIG. 10B illustrates a top perspective view wherein in the RFID antenna is pulled up in accordance with the disclosed architecture.

FIG. 11 illustrates a graph of the RFID antenna performance within the disk seal in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses an RFID antenna that may be formed as part of a conductive material of a container in which at least a portion of the material is removed to retain the barrier properties of the material for the container. Further, an RFID tag device may be coupled outside the barrier layer of the material, such that the RFID tag device does not come in contact with the contents of the container or the contents of the container do not interfere with the readability of the RFID tag. Additionally, in one embodiment, the RFID tag device is coupled after the container is sealed to prevent the RFID tag device from being damaged during the sealing process.

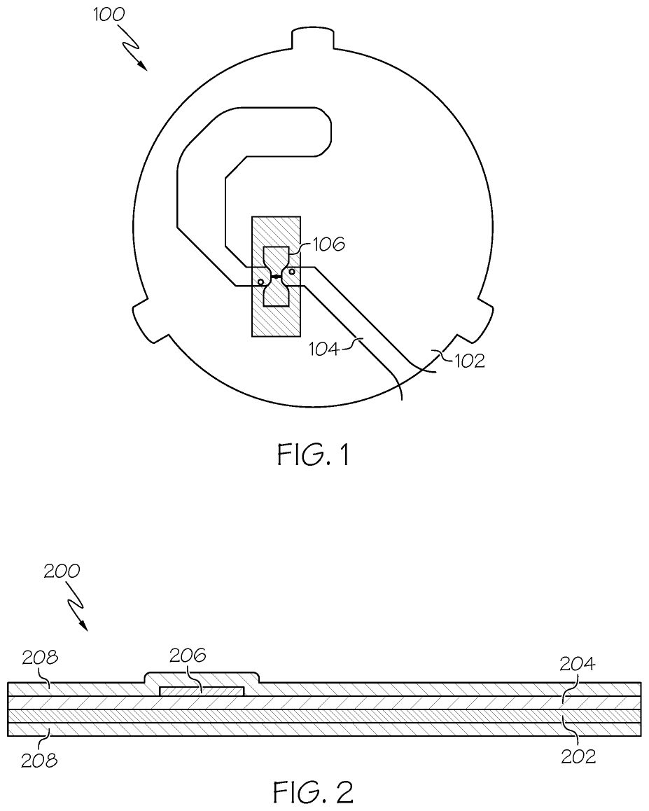

Referring initially to the drawings, FIG. 1 illustrates the RFID antenna structure 100 which is formed as part of a conductive material 102. Generally, the RFID antenna structure 100 is formed from foil or any other suitable conductive material as is known in the art. Exemplary materials include metals, alloys or foils made from metals including for example aluminum, copper, steel, bronze or the like. The RFID antenna structure 100, in one embodiment, is a 36 mm diameter paper-foil disk used on sealed containers such as food and medication containers, or any other suitable sealed containers as is known in the art. While depicted as a generally circumferentially shaped article, the seal and antenna structure can take generally any shape that may work with the container or article to be sealed.

The RFID antenna structure 100 and conductive material 102 can be any suitable size, shape, and configuration as is known in the art without affecting the overall concept of the invention. One of ordinary skill in the art will appreciate that the shape and size of the antenna structure 100 and conductive material 102 as shown in FIG. 1 is for illustrative purposes only and many other shapes and sizes of the antenna structure 100 and conductive material 102 are well within the scope of the present disclosure. In one embodiment of the present invention, the antenna, as in FIG. 1, is in a sloop configuration. Although dimensions of the antenna structure 100 and conductive material 102 (i.e., length, width, and height) are important design parameters for good performance, the antenna structure 100 and conductive material 102 may be any shape or size that ensures optimal performance and sensitivity during use. In addition, the antenna shape may also be such that it can be part of the overall design, branding or trade dress of the packaging so long as the performance remains suitable for the application.

The RFID antenna structure 100 is configured via a single width laser or any other suitable laser or method as is known in the art, such as etching, mechanical die cutter, or the like. The single width laser is used to create (by burning for example) a virtual slot 104 through the conductive material 102. If a laser is utilized, the single width laser burn removes minimal conductive material 102, thus allowing the conductive material 102 to retain its barrier properties. Specifically, the single width laser burn may create a modified sloop type antenna which is burned or cut into the conductive material 102, but in a ‘no strip’ format, such that the conductive material is left in the virtual slot 104 that is created. Thus, by minimizing the amount of conductive material 102 removed to create the antenna (i.e., virtual slot 104), the barrier properties of the conductive material 102 are retained, such that resistance to the passage of oxygen and moisture are not significantly reduced.

Furthermore, the RFID tag device 106, may include a strap as a may be disposed across the virtual slot 104 created by a laser in addition to a chip placed directly onto the antenna. Other connective devices can be used with a chip. The RFID tag device 106 can be secured to either the outside or the inside of the barrier layer having a top 709 and bottom face 711. Specifically, the RFID tag device 106 can be secured to either the conductive material side (i.e., inside the barrier layer) or any associated paper or plastic on the outside of the conductive material (i.e., outside the barrier layer), or on the bottom face of the barrier layer. Securing the RFID tag device 106 outside the barrier layer has the advantage of positioning the RFID tag device 106 away from the contents of the container. If the RFID tag device 106 is not in contact with the contents of the container, then it may not be required for the RFID tag device 106 to be food-safe and/or sterile, but should still be used with an adhesive that does not leach through the sealing and/or barrier layer so as to contaminate the interior of the container. The RFID tag device 106 is coupled via capacitance, magnetic, or mixed mode, or any other suitable means, such as by conductive adhesive as is known in the art for securing the RFID tag device 106 across the virtual slot 104.

Additionally, the RFID tag device 106 can be coupled across the virtual slot 104 before or after the container has been sealed. If the RFID tag device 106 is coupled after the container has been sealed, then the RFID tag device 106 risks less damage, especially if the sealing process involves temperatures, pressures, flexing of the substrate or other factors, such as gamma sterilization, that may damage or destroy the RFID tag device 106.

As illustrated in FIG. 2, a side view of the layered construction of the RFID antenna structure 200 is shown. A conductive layer, such as a laser-cut foil layer 202 is the middle layer and right above this layer is a second material, layer 204 which in one embodiment is constructed out of paper. Other substrates such as PET or other synthetic films or natural materials may be used, including recycled materials. Together these layers create a paper-foil disk used to seal a standard medicine bottle/container, or other similar container. In one embodiment, an RFID tag device, such as a strap 206 is then placed over a virtual slot created in the laser-cut foil layer 202, but the strap 206 is applied on the material 204 side, not on the side of the conductive layer 202. The present invention also contemplates that direct chip attachment, without the use of a strap. A standard hot melt or other permanent pressure sensitive adhesive over-laminate 208 would then be applied to both sides of the structure. Any suitable hot melt or permanent pressure sensitive adhesive over-laminate can be used as is known in the art, and the same hot melt over-laminate can be applied to both sides, or the sides can have different hot melt over-laminates depending on the wants and needs of a user. Further, due to the heat sealing operation, a user may prefer to apply a different over-laminate 208 to the foil layer 202, so as not to damage the adhesive seal or cause additional adhesive ooze due to the re-melting of the adhesive as applied to the paper layer 204.

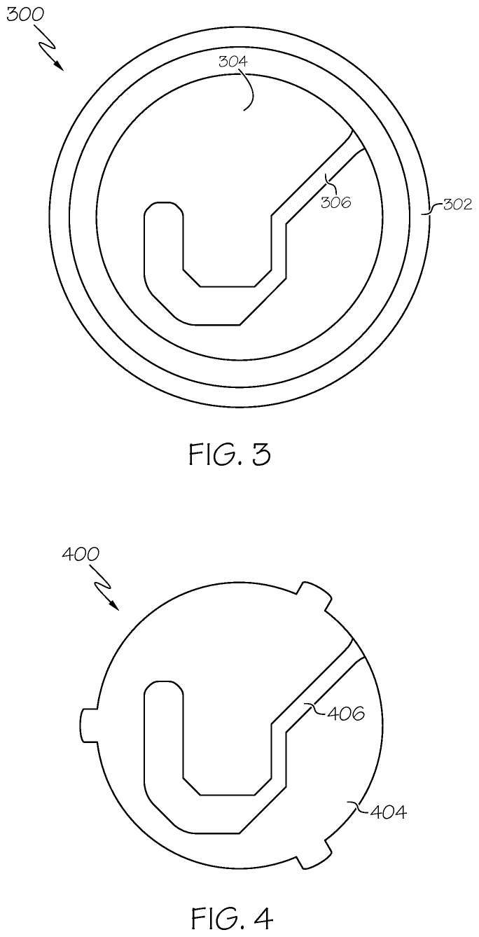

With reference now to FIG. 3, there is illustrated another embodiment of the present invention which the RFID antenna structure 300 is within a lid 302 of a container. A preferred paper-foil disk 304 is used on sealed containers such as food and medication containers, is shown within the lid 302 as it may aid in the recycling. The RFID antenna structure 300 is then configured via a cutter such as a laser, a single width laser, or any other suitable laser as is known in the art including a mechanical die cutter. In addition, the cutting can be done by one or in combination with both devices, e.g. both a laser and a mechanical die cutter. In that example, the laser may cut out the more intricate portions and the mechanical cutter may cut the larger areas. The cutter, or in one embodiment, the single width laser burn is used to create at least one virtual slot 306 through the paper-foil disk 304. Specifically, in one embodiment, the cutter creates a modified sloop type antenna which is burned into the paper-foil disk 304, but in a ‘no strip’ format, such that the conductive material (i.e. the foil) is left in the virtual slot 306 that is created. It is important to note, that will a sloop shape is illustrated, any sort of shape may be created by the laser

With reference now to FIG. 4, there is illustrated the RFID antenna structure 400 shown with the side that would be facing the contents of the container. As stated supra, the standard paper-foil disk 404 used on sealed containers such as food, vitamin, and medication containers is shown. The RFID antenna structure 400 is then configured via a cutter, such as a single width laser burn which is used to create a virtual slot 406 through the paper-foil disk 404. Specifically, the single width laser burn creates a modified sloop type antenna which is burned into the paper-foil disk 404, but in a ‘no strip’ format, such that the conductive material (i.e. the foil) is left in the virtual slot 406 that is created.

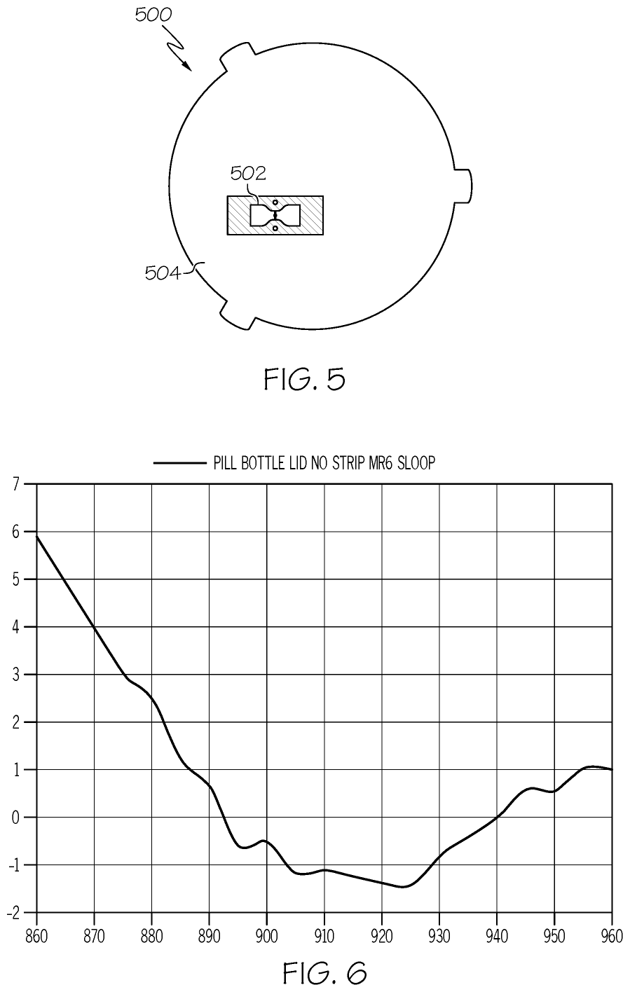

With reference now to FIG. 5, there is illustrated the RFID antenna structure 500 shown with the side that would be facing the lid (or attached within the lid). As stated supra, the standard paper-foil disk 504 used on sealed containers such as food and medication containers is shown. The RFID tag device 502, such as a strap is disposed across the virtual slot created by the single width laser burn. The RFID tag device 502 is secured to the paper or plastic side of the paper-foil disk 504. Where the lid of the container is metal, there can be an additional insulating layer provided or a thicker barrier layer to prevent interference from the metal container or top. Thus, the RFID tag device 502 is secured outside the barrier layer away from the contents of the container. If the RFID tag device 502 is not in contact with the contents of the container, then it is not required for the RFID tag device 502 to be food-safe and/or sterile. Further, the RFID tag device 502 is coupled via capacitance, magnetic, or mixed mode, or any other suitable means as is known in the art for securing the RFID tag device 502 across the virtual slot such as by adhesive. With reference now to FIG. 6, there is illustrated a graph of the performance of the RFID antenna within the standard paper-foil disk, with sensitivity of the antenna peaking at about −1 dBm.

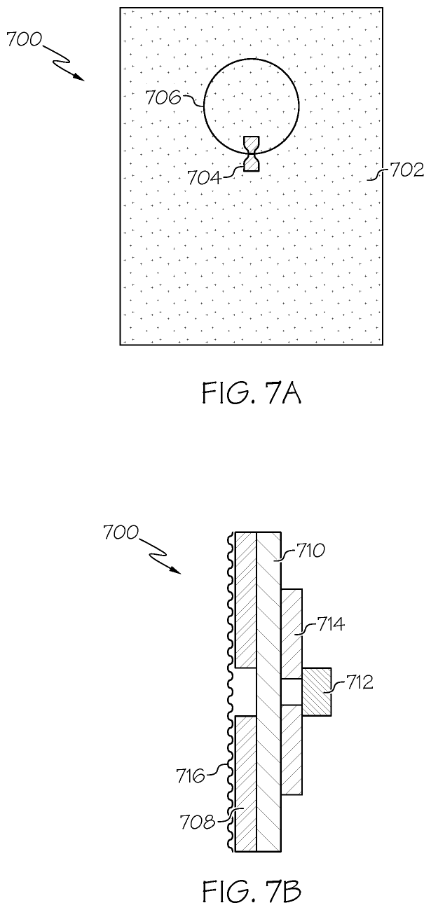

With reference now to FIGS. 7A-B, the RFID antenna structure 700 is shown within a bag (or package or box) 702. Specifically, FIG. 7A discloses the RFID antenna structure 700 configured via a laser burn which is used to create a virtual slot 706 through the bag or package or box 702. Specifically, the single width laser burn creates a modified sloop type antenna which is burned into the bag, but in a ‘no strip’ format, such that the conductive material is left in the virtual slot 706 that is created. The RFID tag device 704, such as a strap is disposed across the virtual slot created by the single width laser burn. The RFID tag device 704 is secured to the paper or plastic side of the bag or package or box 702, outside the barrier layer and away from the contents of the container.

FIG. 7B illustrates a side view of the RFID antenna structure 700. The metal barrier layer 708 is the middle layer and right above this layer is a plastic carrier film 710. An RFID tag device (or chip) 712, such as a strap is then placed over a virtual slot (of a minimal width) created in the metal barrier layer 708, but the RFID tag device 712 is applied on the plastic carrier film 710 side, not the barrier layer 708. The RFID tag device 712 is applied via coupling 714 such as capacitive coupling. An internal coating 716 can also be applied to the outside of the barrier layer 708 as needed. The coating may include print receptive materials, sealing promotors or the like.

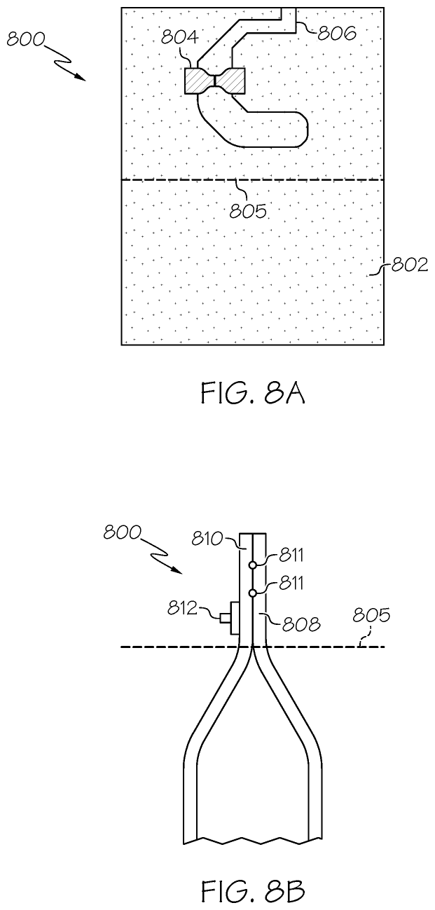

With reference now to FIGS. 8A-B, the RFID antenna structure 800 is shown within another embodiment of a bag (or package or box) 802. Specifically, FIG. 8A discloses the RFID antenna structure 800 configured via a laser which is used to create a virtual slot 806 through the bag, container or package or box 802. Specifically, the single width laser burn creates a modified sloop type antenna which is burned into the bag, but in a ‘no strip’ format, such that the conductive material is left in the virtual slot 806 that is created. The seal then covers any hole created in the container so that the contents are not compromised. Alternatively, the hole may be in an area where there is a multiple thickness such as at an end so that the contents or integrity of the bag or package are not compromised. In one embodiment, the RFID tag device 804, such as a strap is disposed across the virtual slot created by the single width laser burn. The RFID tag device 804 is secured to the paper or plastic side of the bag, container or package or box 802, outside the barrier layer (or sealing edge 805) and away from the contents of the container.

FIG. 8B discloses a side view of the RFID antenna structure 800. The metal film layer 808 is in contact via a plastic layer 810. An RFID tag device (or chip) 812, such as a strap is then placed over a virtual slot (or cuts 811 inside the structure) created in the metal film layer 808, but the RFID tag device 812 is applied on the plastic layer 810 side, not the metal film layer 808, outside the sealing edge 805. The RFID tag device 812 is typically applied via capacitive coupling.

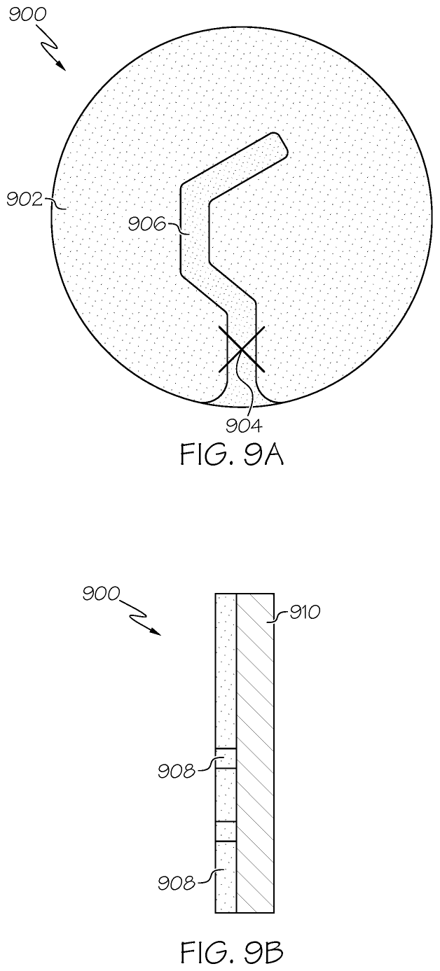

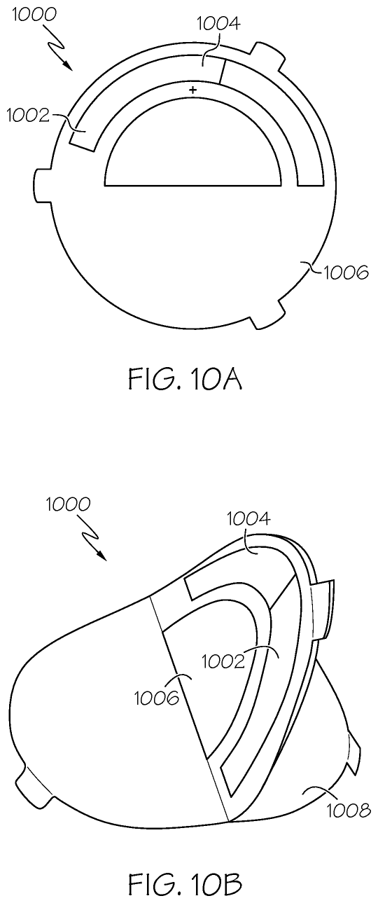

With reference now to FIGS. 9A-B, the RFID antenna structure 900 is shown within a disk seal for a container 902. Specifically, FIG. 9A discloses the RFID antenna structure 900 configured via a single width laser burn which is used to create a virtual slot 906 through the disk seal 902. Specifically, the single width laser burn creates a modified sloop type antenna which is burned into the disk seal, but in a ‘no strip’ format, such that the conductive material is left in the virtual slot 906 that is created. The RFID tag device 904, such as a strap is disposed across the virtual slot created by the single width laser burn. The RFID tag device 904 is secured to the paper or plastic side of disk seal 902, outside the barrier layer and away from the contents of the container.

FIG. 9B discloses a side view of the RFID antenna structure 900. The metallic layer 908 is in contact via a supporting layer 910. An RFID tag device (or chip) 912, such as a strap is then placed over a virtual slot created in the metallic layer 908. The RFID tag device 912 can be applied to either side, the supporting layer 910 side, or the metallic layer 908 side. The RFID tag device 912 is typically applied via capacitive coupling.

With reference now to FIGS. 10A-B, the RFID antenna structure 1000 is disclosed within a disk seal for a container. The antenna 1002 and RFID tag device (or strap) 1004 is positioned above a foam piece 1006, then the whole structure is attached to a continuous foil piece 1008 of the same shape as the foam piece 1006. In use, the antenna 1002 surface is up inside the lid of a container, with the normal foil lid sealed to the container. When the lid is removed, the antenna is pulled up and can be used as a tab to pull the seal off the container (as shown in FIG. 10B). Thus, the RFID antenna structure 1000 requires a round RFID tag 1004 with a dielectric on half of it, where capacitance on the other half couples the structure to the ground, creating a dual purpose structure (i.e., a RFID tag and also a pull tab to pull the seal from the bottle).

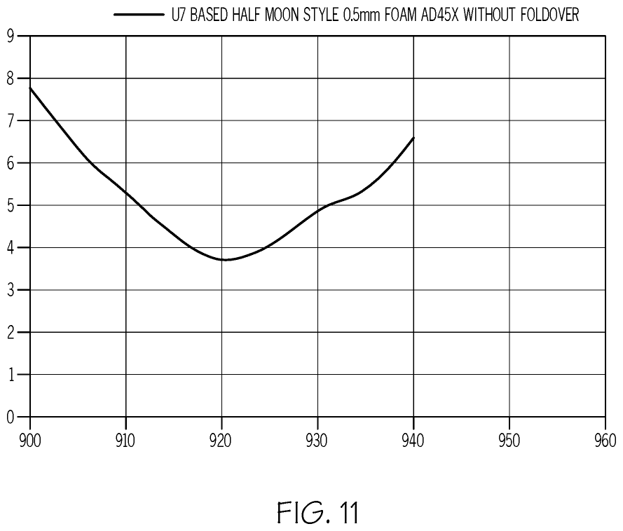

Additionally, the container can comprise an anti-tamper embodiment wherein the RFID tag device is coupled to the outside of the barrier layer and contains an adhesive on it. Thus, when the lid of the container is secured in place, the adhesive and RFID tag device attaches to the interior of the lid. When the lid is removed, the RFID tag device is ripped away from the barrier layer damaging the RFID tag device. With reference now to FIG. 11, there is illustrated a graph of the performance of the RFID antenna within the disk seal. The performance of the RFID antenna requires a specific balance of the capacitive top load and loop dimensions, as well as position to obtain maximum efficiency.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A RFID antenna structure formed from a portion of a conductive material, comprising:
a conductive layer having at least one opening;
a material layer positioned above the conductive layer; and
a laminate applied to both the conductive layer and the material layer.

2. The structure of claim 1, further comprising an RFID tag device coupled over the at least one opening on the material layer side.

3. The structure of claim 2, wherein the RFID tag device is a strap.

4. The structure of claim 1, wherein the material layer is paper.

5. The structure of claim 1, wherein the conductive layer is a foil.

6. The structure of claim 1, wherein the RFID antenna structure is configured via a single width laser.

7. The structure of claim 6, wherein the laser removes or ablates conductive material.

8. A RFID antenna structure within a disk seal for a container, comprising:
an antenna; and
a round RFID tag device comprising a dielectric; and
wherein the antenna and the RFID tag device are positioned above a foam piece; and
wherein the foam piece is attached to a continuous foil piece of same shape as the foam piece.

9. The RFID antenna structure of claim 8, wherein the antenna and the RFID tag device are secured inside a lid of the container, such that when the lid is removed, the antenna and the RFID tag device are also pulled up from the continuous foil piece, creating a pull tab for removing the continuous foil piece.

10. A method of making a RFID antenna structure comprising:
providing a conductive material, a barrier layer, a RFID chip;
providing a cutter;
placing the barrier layer over the conductive layer;
cutting the conductive material to form at least one opening with the cutter; and
applying an adhesive over both sides of the RFID antenna structure to seal it to the container.
